(19) United States
(12) Patent Application Publication
(10) Pub. No.: US 2022/0127943 A1
(43) Pub. Date: Apr. 28, 2022

(54) SYSTEM FOR HYDRAULIC FRACTURING INCLUDING MOBILE POWER-GENERATING SUBSYSTEM WITH DIRECT-COUPLED ELECTROMOTIVE MACHINE INTEGRATED WITH ELECTRICAL ENERGY STORAGE

(71) Applicant: Siemens Energy, Inc., Orlando, FL (US)

(72) Inventors: Dalia El Tawy, Houston, TX (US); Arvind Sriraman, Houston, TX (US); Lynn Wheatcraft, Richmond, TX (US)

(21) Appl. No.: 17/439,745

(22) PCT Filed: Jul. 16, 2019
(86) PCT No.: PCT/US2019/041948

§ 371 Date: Sep. 15, 2021

Related U.S. Application Data
(60) Provisional application No. 62/839,104, filed on Apr. 26, 2019.

(51) Int. Cl. E21B 43/26; H02K 7/18

(52) U.S. Cl. CPC E21B 43/2607; H02K 7/1823

(57) ABSTRACT

System 10 for hydraulic fracturing is provided. The system may include a mobile hybrid power-generating subsystem (25) including a gas turbine engine (14) and an electrical energy storage system (16). Power-generating subsystem (25) further including an electromotive machine (12), such as a switched reluctance electromotive machine or a permanent magnet electromotive machine, in either case having a rotor shaft coupled to a main shaft of the gas turbine engine without a rotational speed reduction device. A power bus (15) being powered by the electrical energy storage system and/or the electromotive machine (12). Gas turbine engine 14, electrical energy storage system 16 and electromotive machine (12) may be arranged on a power generation mobile platform (22) so that a subsystem so arranged can be transportable from one physical location to another, and effectively constitutes a self-contained, mobile hybrid power-generating subsystem that may operate fully independent from utility power or external power sources.

### CROSS-REFERENCE TO RELATED APPLICATIONS

This application claims benefit of the Apr. 26, 2019 filing date of U.S. provisional application 62/839,104, which is incorporated by reference herein.

### BACKGROUND

### 1. Field

Disclosed embodiments relate generally to the field of hydraulic fracturing, such as used in connection with oil and gas applications, and, more particularly, to a system for hydraulic fracturing, and, even more particularly, to system including a power-generating subsystem integrating a gas turbine engine with electrical energy storage and using an electromotive machine directly coupled to the gas turbine engine.

### 2. Description of the Related Art

Hydraulic fracturing is a process used to foster production from oil and gas wells. Hydraulic fracturing generally involves pumping a high-pressure fluid mixture that may include particles/proppants and optional chemicals at high pressure through the wellbore into a geological formation. As the high-pressure fluid mixture enters the formation, this fluid fractures the formation and creates fissures. When the fluid pressure is released from the wellbore and formation, the fractures or fissures settle, but are at least partially held open by the particles/proppants carried in the fluid mixture. Holding the fractures open allows for the extraction of oil and gas from the formation.

Certain known hydraulic fracturing systems may use large diesel engine-powered pumps to pressurize the fluid mixture being injected into the wellbore and formation. These large diesel engine-powered pumps may be difficult to transport from site to site due to their size and weight, and are equally—if not more—difficult to move or position in a remote and undeveloped wellsite, where paved roads and space to maneuver may not be readily available. Further, these large diesel engine powered pumps require large fuel storage tanks, which must also be transported to the wellsite. Another drawback of systems involving diesel engine-powered pumps is the burdensome maintenance requirements of diesel engines, which generally involve significant maintenance operations approximately every 300-400 hours, thus resulting in regular downtime of the engines approximately every 2-3 weeks. Moreover, the power-to-weight ratio of prior art mobile systems involving diesel engine-powered pumps tends to be relatively low.

To try to alleviate some of the difficulties involved with diesel engine-powered fracturing pump systems, certain electrically-driven hydraulic fracturing systems have been proposed. For an example of one approach involving an electric hydraulic system, see International Publication WO 2018/071738 A1.

### BRIEF DESCRIPTION

A disclosed embodiment is directed to a system for hydraulic fracturing. The system may include a power-generating subsystem that may comprise a gas turbine engine; an electrical energy storage system; an electromotive machine directly coupled to the gas turbine engine without a rotational speed reduction device; and a power bus being powered by the electrical energy storage system and/or the electromotive machine. The gas turbine engine, the electrical energy storage system and the electromotive machine may be arranged on a respective power generation mobile platform.

The system may further include a hydraulic fracturing subsystem that may be formed by at least one hydraulic pump driven by an electric drive system electrically powered by the power bus. The hydraulic pump may be arranged to deliver a pressurized fracturing fluid.

### BRIEF DESCRIPTION OF THE DRAWINGS

FIG. 1 illustrates a block diagram of one non-limiting embodiment of a disclosed system that may involve a mobile, hybrid power-generating subsystem integrated with electrical energy storage and an electromotive machine, such as a switched reluctance electromotive machine, mechanically coupled to a gas turbine engine without a rotational speed reduction device.

FIG. 2 illustrates a block diagram of one non-limiting example of a disclosed hydraulic fracturing subsystem, mobile or otherwise, which may be operationally arranged in combination with a mobile, hybrid power-generating subsystem, such as shown in FIG. 1.

FIG. 3 illustrates a block diagram of another non-limiting example of a disclosed hydraulic fracturing subsystem, mobile or otherwise, which may be operationally arranged in combination with a mobile, hybrid power-generating subsystem, such as shown in FIG. 1.

FIG. 4 illustrates a block diagram of another non-limiting embodiment of a disclosed system where the electromotive machine in the mobile, hybrid power-generating subsystem may be a permanent magnet electromotive machine.

FIG. 5 illustrates a block diagram of yet another non-limiting example of a disclosed hydraulic fracturing subsystem, mobile or otherwise, which may be operationally arranged in combination with a mobile, hybrid power-generating subsystem, such as shown in FIG. 4.

### DETAILED DESCRIPTION

The present inventors have recognized that typical prior art systems for hydraulic fracturing may be heavily dependent on the operational availability of prime movers typically based on fossil fuel engine technology, such as diesel engines, and gas turbine engines. To address reliability concerns, well operators may use configurations involving multiple levels of redundancies; for example, N+1 or N+2 redundant engine configurations. Typically, the redundant engines, along with transmissions and pumps mounted on pump trailers, may be hydraulically connected to a given well, but often, at any given time, at least some of the engines may be sub-optimally operated, for example, in an idle mode. Concomitant drawbacks of this redundant approach may include requiring more space at the site, burning increased amounts of fuel, requiring more tractors and drivers, more labor and/or time involved to rig-up and rig-down, all of which significantly adding to operating costs.

At least in view of such recognition, disclosed embodiments formulate an innovative approach for integrating electrical energy storage in a system for hydraulic fracturing. Disclosed embodiments are believed to cost-effectively and reliably provide the necessary power-generation functionality that may be needed to electrically power hydraulic pumps utilized in a fracturing process. This may be achieved by way of optimized utilization of electrical energy derived from a gas turbine engine and electrical energy supplied by an electrical energy storage system.

The present inventors have additionally recognized that in certain prior art systems for hydraulic fracturing the gas turbine engine may be mechanically connected to rotate a synchronous generator via a speed reduction gearbox. For example, the rated rotational speed of the gas turbine engine may vary within a range from approximately 6000 revolutions per minute (rpm) to approximately 14000 rpm, and the rated rotational speed of the generators may vary from approximately 1000 rpm to approximately 3000 rpm.

The present inventors have further recognized that these prior art systems involving gearboxes may suffer from certain drawbacks. For example, the gearboxes may need costly overhauling several times during their respective lifetimes, and may further need periodic servicing of, for example, their substantially complicated lubrication subsystems. For example, the multiple wheels and bearings that may be involved in a gearbox may be operational subject to high levels of stress, and a malfunction of even a single component in the gearbox can potentially bring power generation to a halt, and in turn can result in a substantially costly event (e.g., loss of a well) in a hydraulic fracturing application. This makes the gearbox a relatively high-maintenance part of these prior art systems. Lastly, the prices of the gearboxes can almost equal the prices of the relatively heavy and bulky generators typically involved in these prior art systems.

At least in view of such further recognition, disclosed embodiments formulate an innovative approach in connection with systems for hydraulic fracturing. This approach effectively removes the gearbox from the turbomachinery involved, thus eliminating a technically complicated component of the system, and therefore improving an overall reliability of the system.

Without limitation, disclosed embodiments can take advantage of high-speed, direct-drive electromotive machines (EM) (e.g., machines that may be operable as a generator or as a motor) that may involve state-of-the art electromotive technologies, such as may include switched reluctance electromotive machines (SREM), synchronous reluctance electromotive machines (SynREM), permanent magnet electromotive machines (PMEM), synchronous induction electromotive machines made of light-weight materials and other technologies, which allow the rotor of the machine to reliably rotate at relatively higher speeds compared to the standard rotation speed traditional involved in power generation applications, such as in the order of approximately 10 MW, thereby allowing the electromotive machine to be directly coupled to a high-speed rotating gas turbine engine, such as may involve rotational speeds in the order of approximately 14000 rpm and higher.

Disclosed embodiments of direct coupled turbo-machinery equipment allow integrating an entire power generation subsystem in a relatively compact and lighter assembly, which is more attractive for mobile applications. For example, more suitable for the limited footprint that may be available in mobile hydraulic fracturing applications.

Non-limiting technical features of high-speed electromotive machines that may be used in disclosed embodiments may include designs involving a relatively higher number of rotor/stator poles, advanced bearing technologies, such as magnetic bearing, and single core or multiple cores on a common rotor shaft for multiple voltage level generation. Depending on the needs of a given application, topologies of disclosed embodiments could be adapted to generate alternating current (AC) power or direct current (DC) power. Moreover, such topologies may be optimized to reduce system harmonics, especially in the case of generated DC power (as with an SREM).

Depending on the nature of the generated power, circuit topologies may include AC-DC-AC power conversion, DC-DC, or DC-AC conversion, such as may involve inverter-based variable frequency drives (VFD) or a switched reluctance drive (SRD), such as in embodiments where a switched reluctance motor (SRM) is utilized. As suggested above, advantages obtained from state-of-the-art electromotive technologies may be extended to the electric motors driving the utilization loads, such as one or more hydraulic fracturing pumps. These electric motors can equally benefit from such electromotive technologies, such as including state-of-the-art induction motor technology, switched reluctance motor technology, synchronous reluctance motor technology, or permanent magnet motor technology.

Disclosed embodiments can also offer a compact and self-contained, mobile, hybrid power-generating system having black-start capability for the gas turbine engine. Disclosed embodiments may be configured with smart algorithms to prioritize and determine charging/discharging modes and power source allocation for optimization conducive to maximize the reliability and durability of the power sources involved while meeting the variable power demands of loads that may be involved in the hydraulic fracturing process.

In the following detailed description, various specific details are set forth in order to provide a thorough understanding of such embodiments. However, those skilled in the art will understand that disclosed embodiments may be practiced without these specific details that the aspects of the present invention are not limited to the disclosed embodiments, and that aspects of the present invention may be practiced in a variety of alternative embodiments. In other instances, methods, procedures, and components, which would be well-understood by one skilled in the art have not been described in detail to avoid unnecessary and burdensome explanation.

Furthermore, various operations may be described as multiple discrete steps performed in a manner that is helpful for understanding embodiments of the present invention. However, the order of description should not be construed as to imply that these operations need be performed in the order they are presented, nor that they are even order dependent, unless otherwise indicated. Moreover, repeated usage of the phrase “in one embodiment” does not necessarily refer to the same embodiment, although it may. It is noted that disclosed embodiments need not be construed as mutually exclusive embodiments, since aspects of such disclosed embodiments may be appropriately combined by one skilled in the art depending on the needs of a given application.

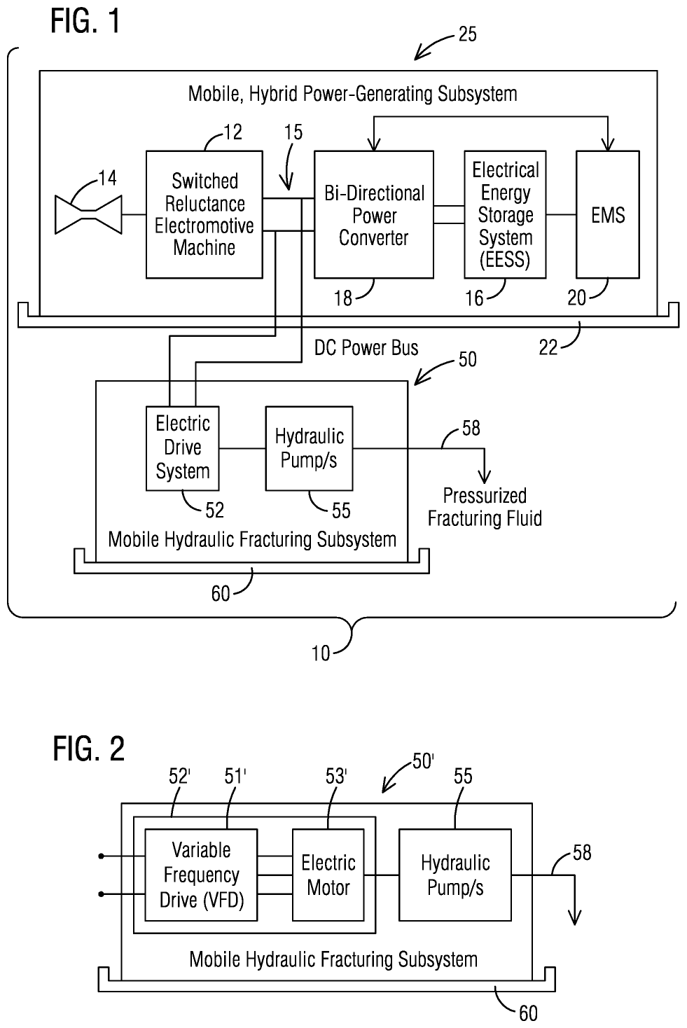

FIG. 1 illustrates a block diagram of one non-limiting embodiment of a system 10 for hydraulic fracturing that may involve a mobile, hybrid power-generating subsystem 25, and may further involve a hydraulic fracturing subsystem 50, mobile or otherwise. As shown in FIG. 1, mobile, hybrid power-generating subsystem 25 may include an electromotive machine 12, such as a switched reluctance electromotive machine, that may have a rotor directly coupled to a gas turbine engine 14 without a rotational speed reduction device. Without limitation, this structural and/or operational relationship may be referred to in the art as involving a high-speed electromotive machine; a direct-coupled electromotive machine; a direct-drive electromotive machine or a gearless-coupled electromotive machine.

In one non-limiting embodiment, a power bus 15 may be powered by an electrical energy storage system 16 and/or the electromotive machine 12. Power bus 15 may be a DC power bus or may be an AC power bus. For example, in the event electromotive machine 12 is a switched reluctance electromotive machine, this machine may be controlled in a power-generating mode to generate DC power and, in this example, power bus 15 would be a DC power bus.

In one non-limiting embodiment, gas turbine engine 14, electromotive machine 12 and electrical energy storage system 16 may each be respectively mounted onto a respective mobile power generation platform 22 (e.g., a singular mobile platform) that can propel itself (e.g., a self-propelled mobile platform); or can be towed or otherwise transported by a self-propelled vehicle and effectively form a self-contained, mobile power-generating system. It will be appreciated that this self-contained, mobile hybrid power-generating subsystem may operate fully independent from utility power or any external power sources.

That is, each of the foregoing components of mobile, hybrid power-generating subsystem 25 may be respectively mounted onto mobile power generation platform 22 so that mobile power-generating subsystem 25 is transportable from one physical location to another. For example, mobile power generation platform 22 may represent a self-propelled vehicle alone, or in combination with a non-motorized cargo carrier (e.g., semi-trailer, full-trailer, dolly, skid, barge, etc.) with the subsystem components disposed onboard the self-propelled vehicle and/or the non-motorized cargo carrier. As suggested above, mobile power generation platform 22 need not be limited to land-based transportation and may include other transportation modalities, such as rail transportation, marine transportation, etc.

In one non-limiting embodiment, gas turbine engine 14 may be an aeroderivative gas turbine engine, such as model SGT-A05 aeroderivative gas turbine engine available from Siemens. There are several advantages of aero-derivative gas turbines that may be particularly beneficial in a mobile fracturing application. Without limitation, an aero-derivative gas turbine is relatively lighter in weight and relatively more compact than an equivalent industrial gas turbine, which are favorable attributes in a mobile fracturing application. Depending on the needs of a given application, another non-limiting example of gas turbine engine 14 may be model SGT-300 industrial gas turbine engine available from Siemens. It will be appreciated that disclosed embodiments are not limited to any specific model or type of gas turbine engine.

In one non-limiting embodiment, electromotive machine 12 may be selectively configured to operate in a motoring mode or in a power-generating mode. Electromotive machine 12, when operable in the motoring mode, may be responsive to electrical power from electrical energy storage system 16 that, without limitation, may be used to provide a black start to gas turbine engine 14. In one non-limiting embodiment, electrical energy storage system 16 may be a battery energy storage system, such as based on lithium-ion battery technology, or other battery technologies, such as flow-based battery technology, or a combination of different battery technologies, etc. For readers desirous of further background information regarding use of batteries for energy storage, reference is made to paper titled “Lead Batteries for Utility Energy Storage: A Review”, by G. J. May, A. Davidson, and B. Monahov, Journal of Energy Storage, Volume 15, February 2018, Pages 145-157, published by Elsevier Ltd.

In one non-limiting embodiment, a bi-directional power converter 18 may be electrically interconnected between energy storage system 16 and switched reluctance electromotive machine 12 to selectively provide bi-directional power conversion between electrical energy storage system 16 and switched reluctance electromotive machine 12. For example, when extracting power from electrical energy storage system 16 to, for example, energize switched reluctance electromotive machine 12 for motoring action, bi-directional power converter 18 may be arranged to convert a DC voltage level supplied by electrical energy storage system 16 to a DC voltage level suitable for driving switched reluctance electromotive machine 12. Conversely, during power-generating action by electromotive machine 12, bi-directional power converter 18 may convert the DC voltage generated by switched reluctance electromotive machine 12 to a DC voltage level suitable for storing energy in electrical energy storage system 16.

In one non-limiting embodiment, hydraulic fracturing subsystem 50 may include one or more hydraulic pumps 55 powered by an electric drive system 52 (e.g., an electric motor alone or in combination with a drive), at least in part responsive to electrical power generated by electromotive machine 12 during the generating mode; or responsive to electrical power generated by electromotive machine 12 in combination with power extracted from electrical energy storage system 16. Hydraulic pump/s 55 may be arranged to deliver a pressurized fracturing fluid, (schematically represented by arrow 58) such as may be conveyed to a well head to be conveyed through the wellbore of a well into a given geological formation.

In the event hydraulic fracturing subsystem 50 is a mobile hydraulic fracturing subsystem, electric drive system 52 and hydraulic pump/s 55 may be mounted on a respective mobile platform 60 (e.g., a singular mobile platform). Structural and/or operational features of mobile platform 60 may be as described above in the context of mobile power generation platform 22. Accordingly, in certain embodiments mobile hydraulic fracturing subsystem 50 may be transportable from one physical location to another.

In one non-limiting embodiment, an energy management system (EMS) 20 may be configured to execute a power control strategy for blending power from electrical energy storage system 16 and power generated by electromotive machine 12 to, for example, appropriately meet variable power demands of hydraulic fracturing subsystem 50.

In one non-limiting embodiment, EMS 20 may be configured to autonomously select electrical energy storage system 16 as a supplemental power source to meet peak loads in mobile hydraulic fracturing subsystem 50. This may be accomplished without having to subject gas turbine engine 14 to thermomechanical stresses that otherwise gas turbine engine 14 would be subject to in order to meet such peak loads, if, for example, electrical energy storage system 16 was not available as a supplemental power source. Similarly, electrical energy storage system 16 may be used as a supplemental power source to compensate for decreased power production of gas turbine engine 14 under challenging environmental conditions, such as high-altitude operation, humid and hot environmental conditions, etc.

In one non-limiting embodiment, EMS 20 may be configured to control a state-of-charge (SoC) of the battery energy storage system. For example, based on the charging input and output requirements of a given application, the battery energy storage system may not be returned to a fully charged condition and may be operated in a partial SoC (PSoC) condition chosen to maximize battery longevity, where the level of PSoC may be tailored based on battery chemistry, environmental conditions, etc.

In one non-limiting embodiment, components of mobile, hybrid power-generating system 25, such as bi-directional power converter 18, and EMS 20 may each be mounted onto mobile power generation platform 22 in combination with gas turbine engine 14, electromotive machine 12 and electrical energy storage system 16.

In one non-limiting embodiment, EMS 20 may be configured to autonomously select electrical energy storage system 16 as a supplemental power source to stabilize voltage and/or frequency deviations that may arise during transient loads in mobile hydraulic fracturing subsystem 50.

In one non-limiting embodiment, the electrical energy storage system may optionally comprise a hybrid, electrical energy storage system (HESS), such as may involve different types of electrochemical devices, such as without limitation, an ultracapacitor (UC)-based storage module and a battery-based energy storage module. The basic idea is to synergistically combine these devices to achieve a better overall performance. For example, batteries have a relatively high energy density, which varies with chemistry and power density of the specific battery technology involved. Compared to batteries, UCs have a relative lower energy density but substantially higher power density. Additionally, the life of UCs may typically be over approximately one million cycles, which is relatively higher than that of batteries. Also, UCs may have superior low-temperature performance compared to batteries. These various characteristics allow for an optimal combination that may be tailored to achieve an improved overall performance in a given hydraulic fracturing application. For readers desirous of further background information regarding various alternative circuit topologies that may be used based on the needs of a given application, see paper titled “A New Battery/Ultracapacitor Hybrid Energy Storage System for Electric, Hybrid, and Plug-In Hybrid Electric Vehicles by J. Caoa and A. Emadi, published in IEEE Transactions on Power Electronics, Vol. 27, No. 1 Jan. 2012.

The following are-non-limiting examples of attractive characteristics of a SREM that have been recognized by Applicant as effective to realizing novel technical solutions by disclosed embodiments for hydraulic fracturing applications:
Substantially high power-to-weight ratio;
Straightforward construction, such as rotor construction of laminated steel, without permanent magnets or windings;
High efficiency over a wide speed range;
Can reliably operate at high-speeds and high-temperatures since, for example, the rotor can act as a cooling source to the stator;
Relatively high reliability since, for example, each phase is electrically and magnetically independent from one another.

For readers desirous of further background information, see for example, technical paper titled “State of the Art of Switched Reluctance Generator”, by A. Arifin, I. Al-Bahadly, S. C. Mukhopadhyay, published by Energy and Power Engineering, 2012, 4, 447-458, Copyright © 2012 Scientific Research.

The description below will now proceed to describe components illustrated in FIG. 2 that may be used by a hydraulic fracturing subsystem 50′ powered by mobile, hybrid power-generating subsystem 25 (FIG. 1) including switched reluctance electromotive machine 12 configured to generate DC power when in the generating mode so that power bus 15 is a DC power bus. It will be appreciated that electrical power generated by switched reluctance electromotive machine 12 in combination with power extracted from electrical energy storage system 16 may be used to power DC power bus 15.

In this non-limiting embodiment, electric drive system 52′ may include a variable frequency drive (VFD) 51′ electrically coupled to receive power from DC power bus 15. VFD 51′ may have a modular construction that may be adapted based on the needs of a given application. For example, since in this embodiment VFD 51′ is connected to DC power bus 15, VFD 51′ would not include a power rectifier module.

An electric motor 53′, such as without limitation, an induction motor, a permanent magnet motor, or a synchronous reluctance motor, may be electrically driven by VFD 51′. One or more hydraulic pumps 55 may be driven by electric motor 53′ to deliver the pressurized fracturing fluid. As noted above, the modular construction of VFD 51′ may allow to selectively scale the output power of VFD 51′ based on the power ratings of electric motor 53′ and in turn based on the ratings of the one or more hydraulic pumps 55 driven by electric motor 53′.

As will be appreciated by one skilled in the art, techniques involving variable speed operation of an electric motor, in addition to the term VFD, may also be referred to in the art as variable speed drive (VSD); or variable voltage, variable frequency (VVVF). Accordingly, without limitation, any of such initialisms or phrases may be interchangeably applied in the context of the present disclosure to refer to drive circuitry that may be used in disclosed embodiments for variable speed operation of an electric motor. In one non-limiting embodiment, VFD 51′, electric motor 53′, and hydraulic pump/s 55 may be arranged on a respective mobile platform 60 (e.g., a singular mobile platform).

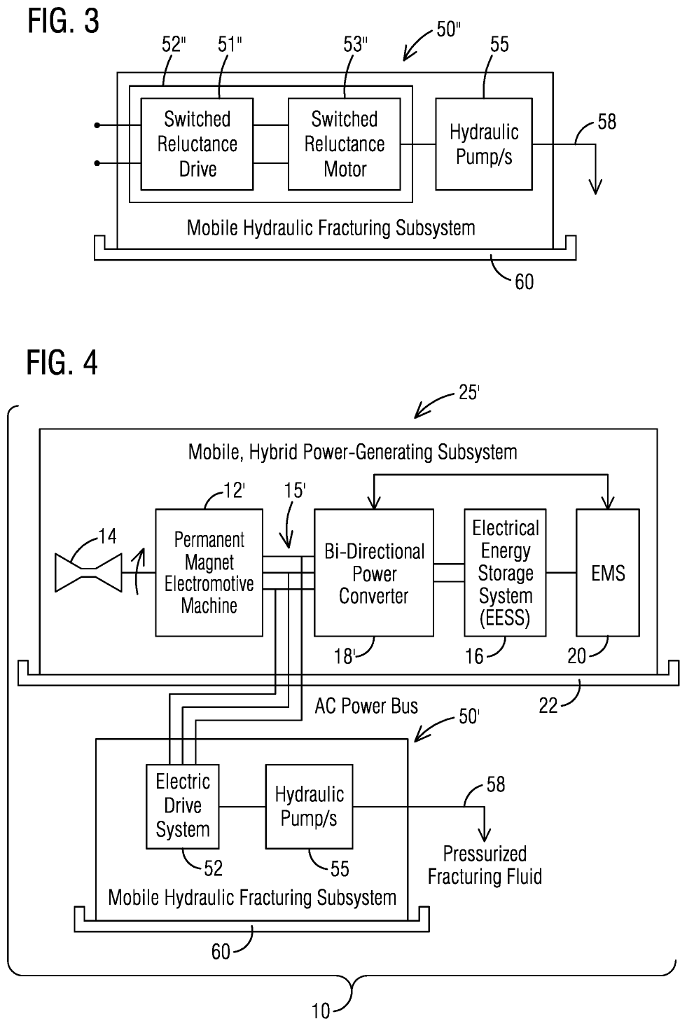

The description below will now proceed to describe components illustrated in FIG. 3 that may be used by a hydraulic fracturing subsystem 50″ powered by mobile, hybrid power-generating subsystem 25 (FIG. 1) including switched reluctance electromotive machine 12 configured to generate DC power when in the generating mode so that power bus 15 is a DC power bus. As noted above, electrical power generated by switched reluctance electromotive machine 12 in combination with DC power extracted from electrical energy storage system 16 may be used to power DC power bus 15.

In this non-limiting embodiment, electric drive system 52″ may include a switched reluctance drive (SRD) 51″ electrically coupled to receive power from DC power bus 15. A switched reluctance motor (SRM) 53″ may be electrically driven by SRD 51″. Hydraulic pump/s 55 may be driven by SRM 53″ to deliver pressurized fracturing fluid 58, as noted above. In one non-limiting embodiment, SRD 51″, SRM 53″, and hydraulic pump/s 55 may be arranged onto singular mobile platform 60. That is, each of such subsystem components may be respectively mounted onto mobile platform 60.

FIG. 4 illustrates a block diagram of yet another non-limiting embodiment of a disclosed system 10 for hydraulic fracturing, such as may involve a mobile, hybrid power-generating subsystem 25′ and a mobile hydraulic fracturing subsystem 50′. In one non-limiting embodiment, electromotive machine 12′ (e.g., the high-speed, direct-drive electromotive machine) in mobile power-generating subsystem 50′, without limitation, may be a permanent magnet (PM) electromotive machine configured to generate AC power when in the generating mode so that power bus 15 is an AC power bus. As noted above, electrical power generated by PM electromotive machine 12 in combination with power extracted from electrical energy storage system 16 may be used to power AC power bus 15.

In one non-limiting embodiment, a bi-directional power converter 18′ may be electrically interconnected between energy storage system 16 and PM electromotive machine 12′ to selectively provide bi-directional power conversion between electrical energy storage system 16 and electromotive machine 12′. For example, when extracting power from electrical energy storage system 16 to, for example, energize PM electromotive machine 12′ for motoring action, bi-directional power converter 18 may be arranged to convert a DC voltage level supplied by electrical energy storage system 16 to an AC voltage suitable for driving PM electromotive machine 12′. Conversely, during power-generating action by PM electromotive machine 12′, bi-directional power converter 18 may convert AC voltage generated by PM electromotive machine 12′ to a DC voltage level suitable for storing energy in electrical energy storage system 16.

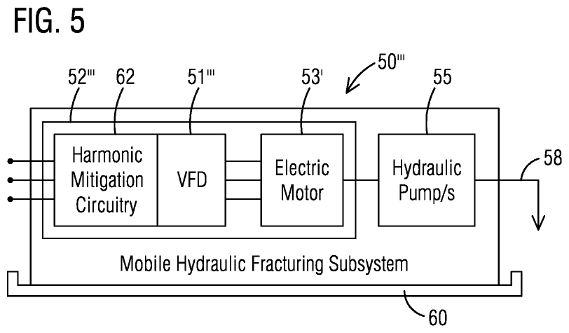

The description below will now proceed to describe components illustrated in FIG. 5 that may be used by a hydraulic fracturing subsystem 50″ when powered by mobile, hybrid power-generating subsystem 25′ (FIG. 4) including PM electromotive machine 12′ configured to generate AC power when in the generating mode so that power bus 15′ is an AC power bus. It will be appreciated that electrical power generated by PM electromotive machine 12′ in combination with power extracted from electrical energy storage system 16 may be used to power AC power bus 15′.

In this non-limiting embodiment, electric drive system 52′″ may include a variable frequency drive (VFD) 51′″ electrically coupled to receive power from AC power bus 15′. In this embodiment, VFD 51′″ being connected to AC power bus 15′ would include a power rectifier module. In one non-limiting embodiment, VFD 51′″ may comprise a six-pulse VFD. That is, VFD 51′″ may be constructed with power switching circuitry arranged to form six-pulse sinusoidal waveforms. As will be appreciated by one skilled in the art, such VFD topology, offers at a lower cost, a relatively more compact and lighter topology than VFD topologies involving a higher number of pulses, such as 12-pulse VFDs, 18-pulse VFDs, etc.

One non-limiting example of VFDs that may be used in disclosed embodiments may be a drive appropriately selected—based on the needs of a given hydraulic fracturing application—from the Sinamics portfolio of VFDs available from Siemens. It will be appreciated that disclosed embodiments are not limited to any specific model of VFDs.

For example, without limitation, one may use sturdy and ruggedized VFDs that have proven to be highly reliable, for example, in the challenging environment of mining applications or similar, and, consequently, are expected to be equally effective in the challenging environment of hydraulic fracturing applications. In one non-limiting embodiment, as indicated in FIG. 5, harmonic mitigation circuitry 62, such as may involve a line reactor may be used to, for example, reduce harmonic waveforms drawn from PM electromotive machine 12′. Electric motor 53′—as noted above may be without limitation, an induction motor, a permanent magnet motor, or a synchronous reluctance motor, —may be electrically driven by VFD 51′″ and in turn electric motor 53′ would drive hydraulic pump's 55 to deliver the pressurized fracturing fluid.

In operation, disclosed embodiments avoid a need of system configurations involving multiple levels of prime mover redundancies and enable a relatively more compact mobile power-generating system easier to transport from site-to-site and easier to move or position in well sites, where paved roads and space to maneuver may not be readily available.

Without limitation, disclosed embodiments are believed to cost-effectively and reliably meet the necessary power-generation needs of hydraulic fracturing subsystem/s by way of optimized utilization of electrical energy derived from a gas turbine engine and electrical energy supplied by an electrical energy storage system. Disclosed embodiments may also offer a self-contained, mobile hybrid power-generating subsystem that may operate fully independent from utility power or external power sources including black-start capability for a gas turbine engine.

In operation, disclosed embodiments are believed to additionally cost-effectively and reliably provide technical solutions that effectively remove gearboxes typically involved in prior art implementations, thus eliminating a technically complicated component of prior art implementations, and therefore improving an overall reliability of disclosed systems. Without limitation, this may be achieved by way of cost-effective utilization of relatively compact, and light-weight electromotive machinery and drive circuitry.

While embodiments of the present disclosure have been disclosed in exemplary forms, it will be apparent to those skilled in the art that many modifications, additions, and deletions can be made therein without departing from the scope of the invention and its equivalents, as set forth in the following claims.

1. A system for hydraulic fracturing,
the system comprising: a gas turbine engine;
an electrical energy storage system;
an electromotive machine having a rotor shaft directly coupled to the gas turbine engine without a rotational speed reduction device;
a power bus being powered by the electrical energy storage system and/or the electromotive machine,
wherein the gas turbine, the electrical energy storage system and the electromotive machine being arranged on a respective power generation mobile platform; and
a hydraulic fracturing subsystem comprising at least one hydraulic pump driven by an electric drive system electrically powered by the power bus, the at least one pump arranged to deliver a pressurized fracturing fluid.

2. The system of claim 1, wherein the electromotive machine comprises a switched reluctance electromotive machine and the power bus comprises a direct current (DC) power bus.

3. The system of claim 2, wherein the switched reluctance electromotive machine is configured to operate in a motoring mode or in a generating mode, the electromotive machine in the motoring mode responsive to electrical power from the electrical energy storage system to provide a black start of the gas turbine engine.

4. The system of claim 3, wherein the electrical energy storage system comprises a battery energy storage system.

5. The system of claim 4, further comprising a bi-directional power converter electrically interconnected between the battery energy storage system and the electromotive machine to selectively provide bi-directional power conversion between the battery energy storage system and the electromotive machine.

6. The system of claim 1, further comprising an energy management system configured to execute a power control strategy for blending power from the electrical energy storage system and power generated by the electromotive machine to meet variable power demands of the hydraulic fracturing subsystem.

7. The system of claim 6, wherein the energy management system is configured to autonomously select the electrical energy storage system as a supplemental power source to meet peak loads in the mobile hydraulic fracturing subsystem.

8. The system of claim 1, wherein the electromotive machine comprises a permanent magnet electromotive machine and the power bus comprises an alternating current (AC) power bus.

9. The system of claim 8, wherein the permanent magnet electromotive machine is configured to operate in a motoring mode or in a generating mode, the permanent magnet electromotive machine in the motoring mode responsive to electrical power from the electrical energy storage system to provide a black start of the gas turbine engine.

10. The system of claim 9, wherein the electrical energy storage system comprises a battery energy storage system.

11. The system of claim 10, further comprising a bi-directional power converter electrically interconnected between the battery energy storage system
and the permanent magnet electromotive machine to selectively provide bi-directional power conversion between the battery energy storage system and the electromotive machine.

12. The system of claim 8, wherein the electric drive system comprises:
a variable frequency drive electrically coupled to the AC power bus; and
an electric motor electrically driven by the variable frequency drive;
wherein the at least one hydraulic pump is driven by the electric motor,
wherein the variable frequency drive, the electric motor, and the at least one hydraulic pump being arranged on a respective mobile platform.

13. The system of claim 12, wherein the variable frequency drive comprises a six-pulse variable frequency drive.

14. The system of claim 13, wherein the six-pulse variable frequency drive includes harmonic mitigation circuitry.

15. The system of claim 12, wherein the electric motor is selected from the group consisting of an induction motor, a permanent magnet motor, and a synchronous reluctance motor.

16. The system of claim 2, wherein the electric drive system comprises:
a variable frequency drive electrically coupled to the DC power bus; and
an electric motor electrically driven by the variable frequency drive;
wherein the at least one hydraulic pump is driven by the electric motor,
wherein the variable frequency drive, the electric motor, and the at least one hydraulic pump being arranged on a respective mobile platform.

17. The system of claim 2, wherein the electric drive system comprises:
a switched reluctance drive electrically coupled to the DC power bus; and
a switched reluctance motor electrically driven by the switched reluctance drive,
wherein the at least one hydraulic pump is driven by the switched reluctance drive,
wherein the switched reluctance drive, the switched reluctance motor, and the at least one hydraulic pump being arranged on a respective mobile platform.
